(19) United States
(12) Patent Application Publication
(10) Pub. No.: US 2025/0141249 A1
(43) Pub. Date: May 1, 2025

(54) ELECTRICAL CIRCUIT FOR CONTROLLING POWER SUPPLY DEVICE IN AN ELECTRICAL DEVICE, AND ELECTRICAL DEVICE

(71) Applicant: Hilti Aktiengesellschaft, Schaan (LI)

(72) Inventor: Michael LACHER, Schwabmuenchen (DE)

(21) Appl. No.: 18/865,939

(22) PCT Filed: May 4, 2023
(86) PCT No.: PCT/EP2023/061837

§ 371 Date: Nov. 14, 2024

(30) Foreign Application Priority Data
May 18, 2022 (EP) 22173948.5

(51) Int. Cl. H02J 7/00

(52) U.S. Cl. CPC H02J 7/0063; H02J 7/0019; H02J 7/0024

(57) ABSTRACT

An electrical circuit for controlling a power draw from a first power supply device and from a second power supply device in an electrical device, in particular in a power tool. The electrical circuit includes a first power supply device and a second power supply device, as well as a first switching element, a second switching element and a third switching element, a coil and two connection points, wherein the coil is present connected in series with the first power supply device and the second power supply device, and wherein the first switching element is configured to bridge the first power supply device and the coil, and the second switching element is configured to bridge the second power supply device and the coil. In this case, an output voltage U_B of the electrical circuit applied to the connection points is greater than a sum of the first voltage U1 of the first power supply device and the second voltage U2 of the second power supply device.

The invention relates to an electrical circuit for controlling a power draw from a first power supply device and from a second power supply device in an electrical device, in particular in a power tool.

### BACKGROUND

Electrical devices, such as power tools, with which different types of work can be carried out are known in the prior art. For example, hammer drills, chisels, cut-off or angle grinders, screwdrivers or core drills are known in each of which a tool is driven by a motor. A power supply can be provided via a mains connection or with power supply devices, batteries or accumulators.

A number of applications of such power tools are known, in which high powers are required in order to carry out the corresponding work. In the case of power tools of which the power supply is formed by a power supply device, it may happen that the power required for the work exceeds the maximum possible output power of the power supply device. In order to meet this challenge, such power tools are often equipped with an interface for two power supply devices in order to be able to provide the desired power with two power supply devices that can be connected in series.

### SUMMARY OF THE INVENTION

However, when working with tool devices with two or more power supply devices, the following problem may occur: situations may arise in which the state of charge (“SOC”) of the power supply devices is not the same. A similar situation may also occur when different types of power supply devices are used, for example a 5 ampere-hour (Ah) power supply device and a 10 Ah power supply device. If, for example, one of the power supply devices is completely or partially discharged, full power cannot be provided for the power tool over the entire working period. As soon as one of the power supply devices is completely discharged, no further power can be drawn from this power supply device when the power supply devices are connected in series. It may then be necessary to stop working with the power tool—despite any remaining charge possibly present in the other power supply device.

In particular, the energy or power available for work with the power tool is determined by the smallest amount of charge contained in one of the power supply devices when there are multiple power supply devices. In other words, the power supply device with the lowest SOC value determines the power available for the power tool and the range at which work can be performed with the power tool.

An object of the present invention is to overcome the above-described shortcomings and disadvantages of the prior art and to provide an improved electrical device and an electrical circuit for controlling a power draw from a first power supply device and from a second power supply device in an electrical device, in particular in a power tool, with which the power draw from the individual power supply devices can be controlled differently.

The present invention provides an electrical circuit for controlling a power draw from a first power supply device and from a second power supply device in an electrical device, in particular in a power tool. The electrical circuit comprises a first power supply device and a second power supply device, as well as a first switching element, a second switching element and a third switching element, a coil and two connection points. The coil is present in series with the first power supply device and the second power supply device, and the first switching element is configured to bridge the first power supply device and the coil, while the second switching element is configured to bridge the second power supply device and the coil. In this case, an output voltage U_B of the electrical circuit applied to the connection points is greater than a sum of the first voltage U1 of the first power supply device and the second voltage U2 of the second power supply device. Advantageously, the electrical circuit is capable of equalizing charges between the power supply devices when the switching elements are connected accordingly.

Closing the first switching element charges the coil with electrical energy from the first power supply device. The amount of energy or the charge increases here substantially proportionally with the charging time t. Similarly, closing the second switching element charges the coil with electrical energy from the second power supply device. Again, the amount of energy or charge increases here substantially proportionally with the charging time t. When the first and second switching elements are closed, the electrical energy stored in the coil can be discharged into the load circuit by closing the third switching element. Since the ratio of the switch-on times of the first and second switching elements preferably controls the discharge amount of the first and second power supply devices, unequal switch-on times and/or unequal discharge can be used to balance the state of charge of the two power supply devices.

The electrical circuit is additionally capable of boosting, or increasing to a value greater than the sum of the voltages of the two power supply devices, an output voltage U_B of the electrical circuit that is preferably applied at the connection points of the electrical circuit. The circuit may also preferably be referred to as a “boost circuit” in the context of the invention, wherein the ability to boost the voltage within the circuit is particularly effected by the coil and its arrangement within the circuit. The coil is present arranged in series with the power supply devices. Thus, the invention relates in particular to a boost converter for two power supply devices having a charge equalizing function, wherein the power supply devices are preferably arranged in an electrical device, for example in a power tool. The equalization of charges between power supply devices or between the cells of a power supply device is preferably also referred to as “balancing” in the context of the invention.

In particular, the invention can enable the energy draw from the power supply devices to be controlled differently. In the context of the invention, this preferably means that different amounts of energy can be drawn from the power supply devices per unit of time. In this way, it can advantageously also be made possible to compensate for different charge states in the power supply devices in the sense of a “balancing”. Advantageously, the energy or charge present or stored in the power supply devices can thereby be better utilized, since the energy and/or charge can be provided or made available to the electrical device at a higher voltage.

By arranging the coil between the two power supply devices and the two switching elements, it is possible to dynamically adjust and thus control the charging time of the coil. The inventor has recognized that the charging time of the coil corresponds substantially to the energy draw from the power supply devices. Thus, by being able to adjust the charging time of the coil, it is also possible to adjust or control the power draw from the power supply devices of the electrical circuit or the electrical device. In this way, it becomes possible to load the two power supply devices differently or to draw different amounts of electrical energy from them. Preferably, the first and second switching element may be MOSFETs. It is preferred in the context of the invention that the first and second switching elements can each bridge a power supply device and the coil, so that the charging time of the coil can be changed or adjusted. Preferably, the coil is also referred to as an “inductor” in the context of the invention, wherein in particular, the coil is configured to be charged with electrical current. By varying the charging times of the coil, the power supply devices of the electrical circuit can advantageously be loaded differently, i.e., different amounts of electrical energy can thereby be drawn from the power supply devices.

It is preferred in the context of the invention that the electrical circuit is configured to load the two power supply devices differently, thereby balancing the state of charge.

In particular, the ability to step up the output voltage U_B of the electrical circuit is due in particular to the coil being connected in series with the first power supply device and the second power supply device, and to the first switching element being configured to bridge the first power supply device and the coil, while the second switching element is configured to bypass the second power supply device and the coil.

It is preferred in the context of the invention that the third switching element is configured to switch on or off a state of the electrical circuit, wherein, in this state, an output voltage U_B of the electrical circuit applied to the connection points is greater than a sum of the first voltage U1 of the first power supply device and the second voltage U2 of the second power supply device. In the context of the invention, the phrase “greater than” includes the phrase “greater than or equal to”, so that the phrase that an output voltage U_B of the electrical circuit applied to the connection points is greater than a sum of the first voltage U1 and the second voltage U2 can preferably also mean that the output voltage U_B is equal to the sum U1+U2 of the voltage of the two power supply devices. In other words, the output voltage U_B of the electrical circuit applied to the connection points may be greater than or equal to the sum of the first voltage U1 of the first power supply device and the second voltage U2 of the second power supply device. Within the meaning of the invention, this state is preferably also referred to as a “boost state”. Preferably, the third switching element is configured to act as a boost switching element or boost diode. Increasing the output voltage U_B to a value greater than the sum of the voltages of the two power supply devices is referred to as “boosting” in the context of the invention. Preferably, the first power supply device is configured to provide the first voltage U1, while the second power supply device is configured to provide the second voltage U2. By way of the advantageous embodiment of the electrical circuit, an output voltage U_B can be provided that is greater than a sum of the individual voltages. In this boost state, the following relation applies:

U_B>U1+U2.

It is preferred in the context of the invention that the first switching element and/or the second switching element is/are designed as a metal-oxide-semiconductor field-effect transistor (MOSFET). Preferably, the first switching element and/or the second switching element can also be formed as field-effect transistors (FET) or insulated gate bipolar transistors (IGBT). Preferably, the third switching element may be formed as a diode. However, the third switching element can also be formed as a MOSFET, as shown in the figures.

In a second aspect, the invention relates to an electrical device, in particular a power tool, wherein the electrical device comprises an electrical circuit. The definitions, technical effects and advantages described for the electrical circuit apply analogously to the electrical device. In particular, the electrical device comprises two power supply devices, which may also be part of the electrical circuit. With the invention, the charge or electrical energy available in the power supply devices can be utilized to a higher degree for the electrical device, so that the energy contained in the power supply devices can be better utilized than in conventional electrical devices as are known from the prior art.

In the context of the invention, it is preferred that the power supply devices of which the states of charge are to be equalized have the same or substantially identical nominal voltages. However, it can also be preferred in the context of the invention for the power supply devices to have different nominal voltages. For example, in the context of the present invention, two different power supply devices having voltages of 12 V and 36 V may be present with each other in a power tool. In such combinations of power supply devices with different equalizing voltages, it may be desired that the power supply devices have equal or substantially equal states of charge after the equalization process. However, it may also be preferred that the states of charge merely balance each other out. The term “balance” preferably means, in the context of the invention, that a difference in the states of charge between the power supply devices is reduced.

It is preferred in the context of the invention that the power to be provided by the invention be equal to the sum of the individual powers of the two power supply devices.

The invention allows all of the energy stored in the power supply devices to be converted and used to operate the power tool. Advantageously, this allows the running time of the power tool to be extended without having to replace or recharge the power supply devices.

### BRIEF DESCRIPTION OF THE DRAWINGS

Further advantages can be found in the following description of the figures. An exemplary embodiment of the present invention is shown in the figures. The figures, the description and the claims contain numerous features in combination. A person skilled in the art will expediently also consider the features individually and combine them to produce useful further combinations.

Identical and similar components are denoted by the same reference signs in the figures,

in which:

FIG. 1 shows a schematic representation of an exemplary embodiment of the electrical circuit

FIG. 2 shows a schematic representation of an exemplary embodiment of the electrical circuit

### DETAILED DESCRIPTION

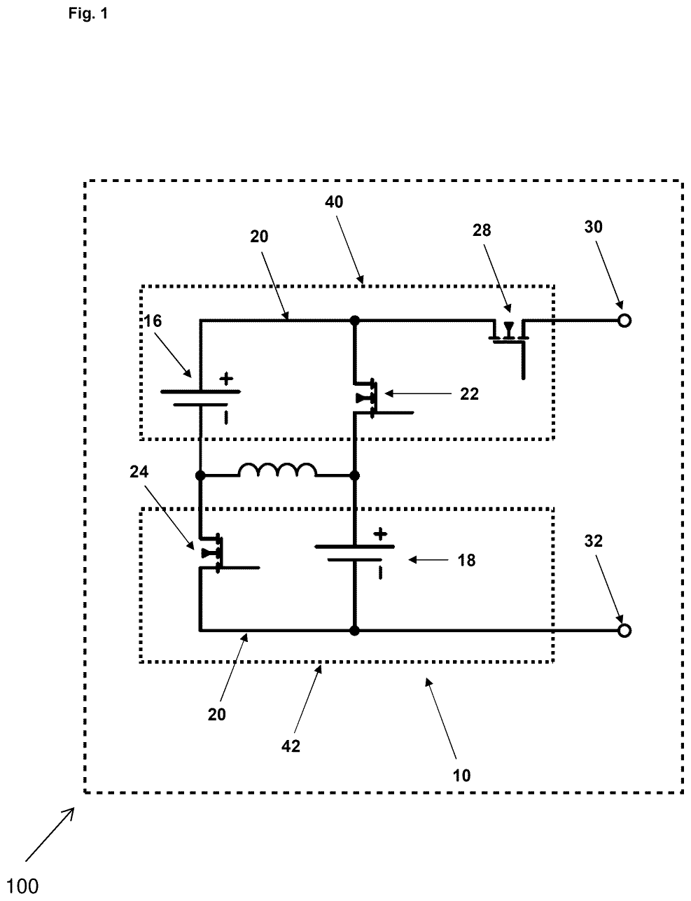

FIG. 1 shows an exemplary embodiment of the electrical circuit 10 for a power tool 100 shown solely schematically. The electrical circuit 10 has a first power supply device 16 and a second power supply device 18, and a coil 26. In addition, the electrical circuit 10 comprises a first switching element 22, a second switching element 24, and a third switching element 28.

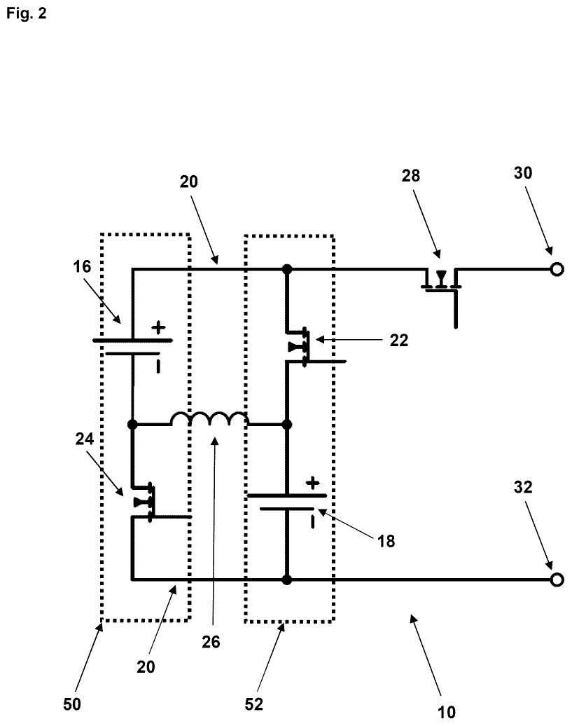

The electrical circuit 10 can be described in terms of an upper half 40 and a lower half 42. These halves 40, 42 of the electrical circuit 10 are represented in FIG. 1 by the rectangles with the dashed side lines. The upper half 40 and the lower half 42 of the electrical circuit 10 are separated from each other by the coil 26 (see, e.g. FIG. 2), wherein the coil 26 is present arranged in series with the power supply devices 16, 18 of the electrical circuit 10. Each of the two halves 40, 42 of the electrical circuit 10 comprises a power supply device 16, 18 and a switching element 22, 24. For example, the upper half 40 of the electrical circuit 10 may comprise the first power supply device 16 and the first switching element 22, wherein the first power supply device 16 and the first switching element 22 are connected to each other via the coil 26 and an electrical line 20. In particular, the electrical line 20 is present here arranged between the positive terminal “+” of the first power supply device 16 and the first switching element 22, while the coil 26 is present arranged between the negative terminal “−” of the first power supply device 16 and the first switching element 22. On the other side of the electrical circuit 10, the lower half 42 of the electrical circuit 10 may comprise the second power supply device 18 and the second switching element 24, wherein the second power supply device 18 and the second switching element 24 are connected to each other via the coil 26 and an electrical line 20. In particular, the electrical line 20 is present here arranged between the negative terminal “−” of the second power supply device 18 and the second switching element 24, while the coil 26 is present arranged between the positive terminal “+” of the second power supply device 18 and the second switching element 24.

The upper half 40 and the lower half 42 of the electrical circuit 10 are separated from each other by the coil 26. The third switching element 28 may be present in either the upper half 40 or the lower half 42 of the electrical circuit 10. In the exemplary embodiment of the invention shown in the figures, the third switching element 28 is present arranged in the upper half 42 of the electrical circuit 10.

The electrical circuit 10 may also be described as composed of a front strand 50 and a rear strand 52. These strands 50, 52 of the electrical circuit 10 are represented in FIG. 2 by the rectangles with the dashed side lines. The front strand 50 of the electrical circuit 10 comprises the first power supply device 16 and the second switching element 24, while the rear strand 52 comprises the second power supply device 18 and the first switching element 22. The coil 26 is located between the two strands 50, 52 and separates the strands 50, 52 of the electrical circuit 10 from each other. Here, the first power supply device 16 and the first switching element 22 are present on the upper side 40 of the electrical circuit 10, i.e., above the coil 26, while the second power supply device 18 and the second switching element 24 are present arranged on the lower side 44 of the electrical circuit 10, i.e., below the coil 26.

### LIST OF REFERENCE SIGNS

10 electrical circuit
16 first power supply device
18 second power supply device
20 electrical line
22 first switching element
24 second switching element
26 coil
28 third switching element
30 first connection point
32 second connection point
40 upper half of the electrical circuit
42 lower half of the electrical circuit
50 front strand of the electrical circuit
52 rear strand of the electrical circuit

1-6. (canceled)

7: An electrical circuit for controlling a power draw from a first power supply device and from a second power supply device in an electrical device, in particular in a power tool, the electrical circuit comprising:
a first power supply device; and
a second power supply device;
a first switching element;
a second switching element;
a third switching element;
a coil; and
two connection points, the coil connected in series with the first power supply device and the second power supply device, the first switching element being configured to bridge the first power supply device and the coil, and the second switching element being configured to bridge the second power supply device and the coil, an output voltage of the electrical circuit present at the two connection points being greater than a sum of a first voltage of the first power supply device and a second voltage of the second power supply device.

8: The electrical circuit as recited in claim 7 wherein the first switching element or second switching element is a MOSFET.

9: The electrical circuit as recited in claim 8 wherein the third switching element a diode.

10: The electrical circuit as recited in claim 7 wherein the third switching element a diode.

11: The electrical circuit as recited in claim 7 wherein the third switching element is configured to switch a state of the electrical circuit on or off.

12: An electrical device comprising the electrical circuit as recited in claim 7.

13: The electrical device as recited in claim 12 wherein the electrical device is a power tool.
